(19) United States
(12) Patent Application Publication
(10) Pub. No.: US 2011/0232514 A1
(43) Pub. Date: Sep. 29, 2011

(54) PRINTING APPARATUS FOR PRINTING BOTTLES OR SIMILAR CONTAINERS

(75) Inventors: Frank Putzer, Hamburg (DE); Katrin Preckel, Gelsenkirchen (DE); Manfred Pschichholz, Kamen (DE); Martin Schach, Bochum (DE)

(73) Assignee: KHS GmbH, Dortmund (DE)

(21) Appl. No.: 13/133,058

(22) PCT Filed: Feb. 19, 2010
(86) PCT No.: PCT/EP2010/001042

§ 371 Date: Jun. 6, 2011

(30) Foreign Application Priority Data
Mar. 19, 2009 (DE) 10 2009 013 477.8

(51) Int. Cl. B41F 17/08

(52) U.S. Cl. 101/36

(57) ABSTRACT

The invention relates to a printing apparatus for printing bottles or similar containers, having several printing positions on a transport element, which can be driven in rotation, by which the printing positions and/or the containers are moved on a closed path of movement between at least one container take-up and at least one container drop, having rotating print heads for applying at least one print image, preferably multi-color, onto a region to be printed on the external container surface of the containers, in the event of relative movement of the external container surface and at least one print head, wherein at least one enclosure is present, into which each of the containers, which are provided at a print position, is housed during the printing process with at least the region to be printed thereof.

The invention relates to a printing apparatus according to preamble patent claim 1 and thereby specifically to a printing apparatus for printing containers using at least one electronically or digitally triggerable print head.

The printing and in particular the direct printing of containers is fundamentally known, especially including in the form that the preferably polychrome print image applied to the container concerned constitutes an essential element of the equipping of the container concerned similarly to a conventional label for example. Electrostatic print heads, such as for example inkjet print heads or print heads known under the designation “Tonejet”, i.e. print heads which operate according to the inkjet printing principle or Tonejet principle and which exhibit a plurality of single nozzles disposed sequentially in at least one row on an active print head side in a print head longitudinal axis and which can be individually triggered to dispense ink, printing ink and/or for example coatings and protective paints, are often used in this regard. In the sense of the invention, the term ink, printing ink or the like is to be understood quite generally to mean an operating material with which the print image concerned is generated with different quality attributes by using the print head.

One specific problem encountered in particular with printing apparatus for the printing of containers using print heads that operate according to the inkjet printing or Tonejet principle, is that during the printing process, part of the printing ink does not end up on that region of the exterior surface of the container which is to be printed but is instead sprayed out into the surrounding air where it forms an aerosol consisting of finely distributed ink or printing ink particles. These atomized particles of ink or printing ink then settle undesirably inter alia on elements of the printing apparatus concerned, causing contamination that can only be removed with a considerable amount of cleaning.

Known printing apparatuses are further problematic in that, especially at high rates of production, the containers are moved at high conveying speeds during printing, one consequence of this being strong air swirls or turbulence around the containers resulting in a blurring of the printing ink and in errors or quality losses when printing.

The object of the invention is to provide a printing apparatus which avoids disadvantages of this kind and ensures high quality printed images without the risk of the printing apparatus being contaminated by printing ink. A printing apparatus device according to patent claim 1 is configured to achieve this object.

Further embodiments, advantages and possible applications of the invention arise out of the following description of embodiments and out of the figures. All of the described and/or pictorially represented attributes whether alone or in any desired combination are fundamentally the subject matter of the invention independently of their synopsis in the claims or a retroactive application thereof. The content of the claims is also made an integral part of the description.

The invention is explained below through the use of embodiment examples with reference to the figures. This is depicted by:

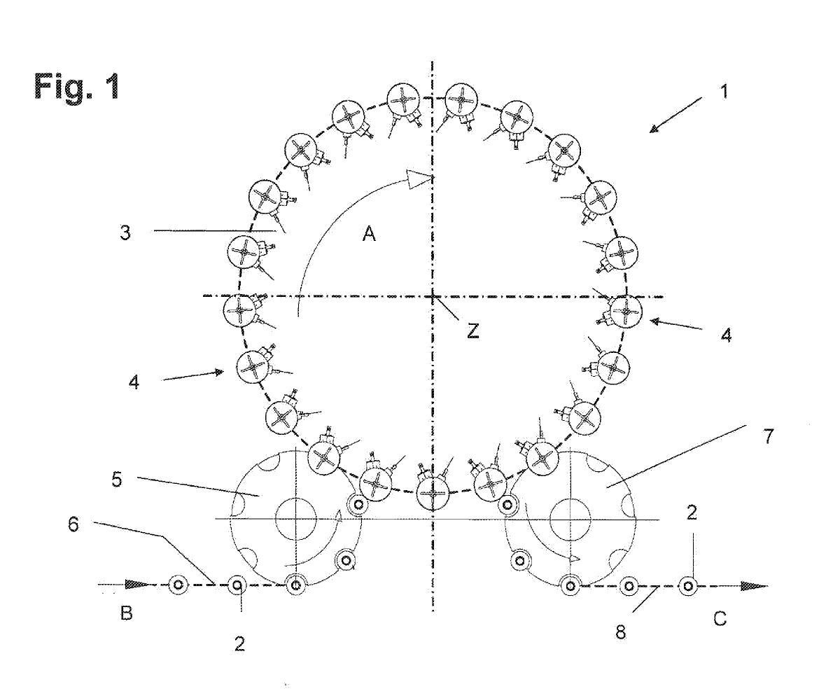

FIG. 1 in simplified representation and in plan view, a printing apparatus for the direct printing of containers, for example with print heads which operate according to the inkjet printing principle or Tonejet principle;

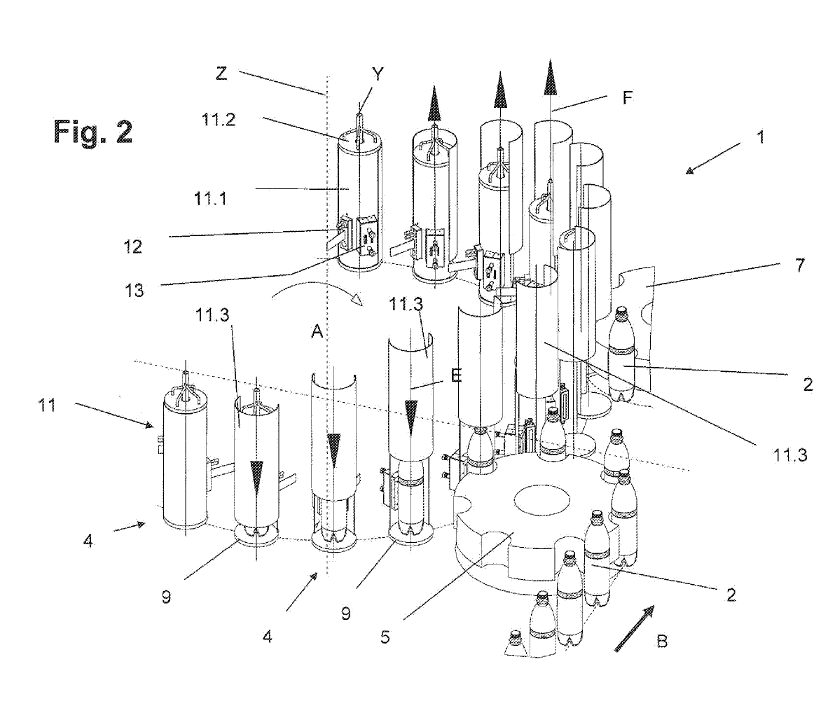

FIG. 2 in simplified perspective representation, a number of the printing positions disposed around the periphery of a rotor;

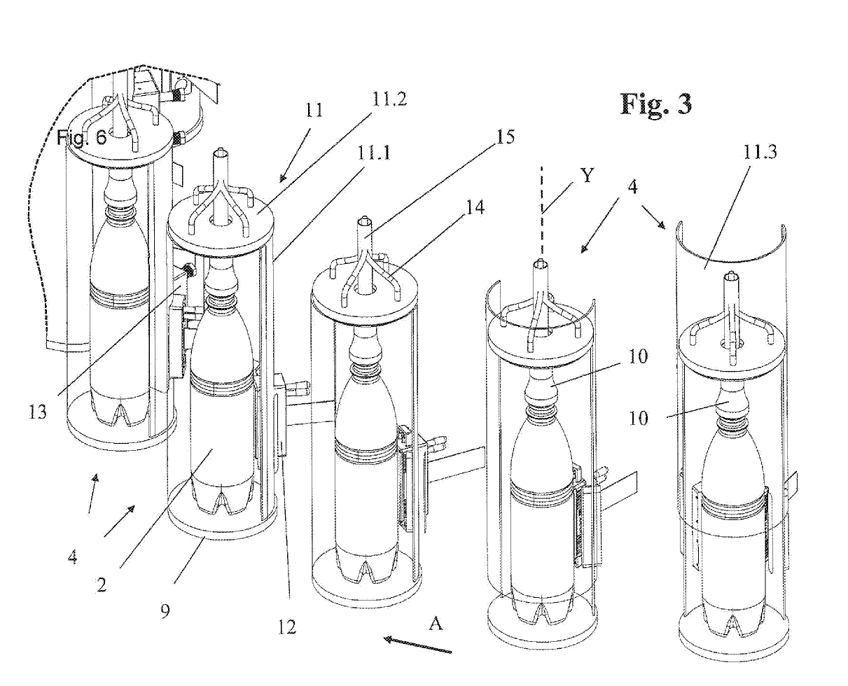

FIG. 3 in enlarged perspective representation, a number of the printing positions disposed around the periphery of the rotor;

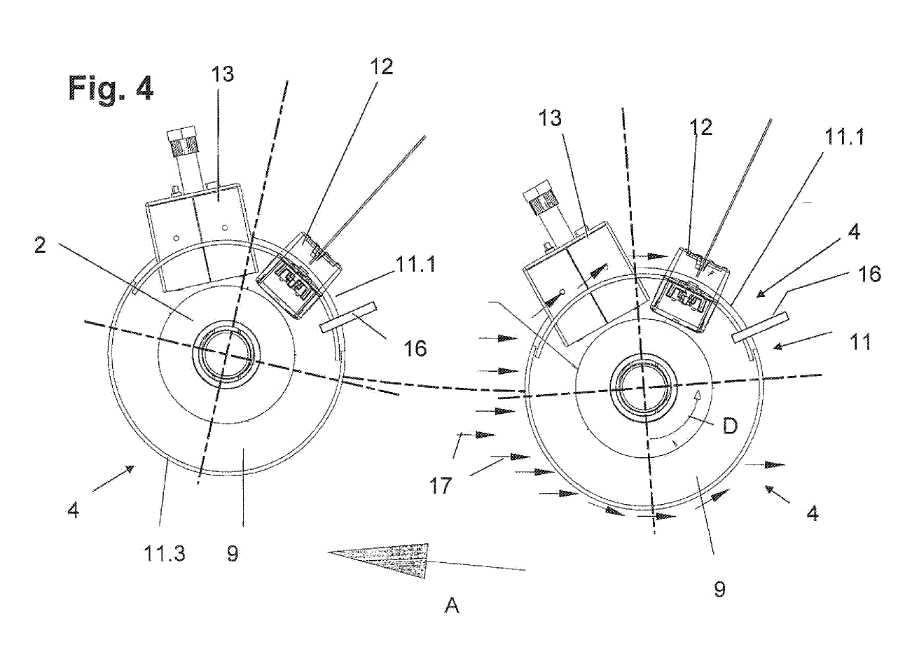

FIG. 4 in enlarged partial representation and in plan view, two of the printing positions disposed on the periphery of the rotor;

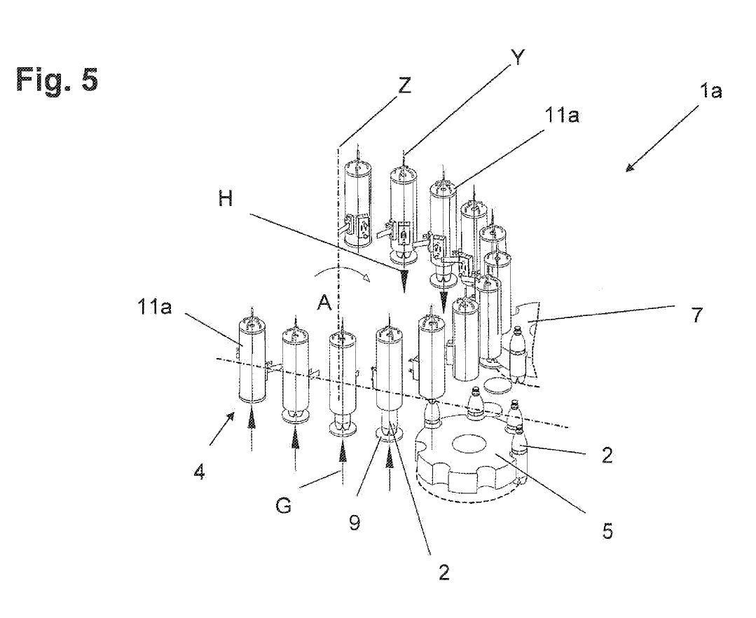

FIG. 5 A representation similar to FIG. 2 with a further embodiment of the invention.

The printing apparatus generally labelled as 1 in FIGS. 1-4 is used for the direct printing of containers which in the depicted embodiment are bottles and specifically PET bottles 2.

The printing apparatus 1 comprises inter alia a printing wheel or rotor 3 that can be rotationally (arrow A) driven about a vertical machine axis Z and on whose periphery a plurality of handling or printing positions 4 are disposed at evenly distributed angular distances about the machine axis Z.

The bottles 2 to be printed are fed by means of an outer conveyor 6 to a container intake of the printing apparatus 1 exhibiting an infeed star 5, standing upright, i.e. with their bottle axis vertically oriented and succeeding one another in the transport direction B of the conveyor 6, each arriving at a printing position 4 via the infeed stand 5. The printed bottles 2 are each taken from the printing position 4 at a container discharge exhibiting an outlet star 7 and fed via an outer conveyor 8 in the latter's direction of transport C to a subsequent use.

Each printing position essentially comprises a container carrier which in the depicted embodiment is formed of a bottle or container plate 9 and can be controlled to rotate or swivel about its container plate axis Y that runs parallel to the machine axis Z (arrow D). Moreover each printing position 4 has a plunger 10 with which the respective bottle 2 is inter alia secured from tipping over after it transfers to the printing position 4 by its being clamped between the container plate 9 and the plunger 10. Each plunger 10 can be controlled to move down and up on rotary plate axis Y to secure and to release the respective bottle 2.

Each of the printing positions 4 also comprises a sleeve-like enclosure or protective sleeve 11 which in the case of printing apparatus 1 is configured in three parts and which in the closed condition encloses and houses the bottle 2 provided at the printing position 4 concerned over its entire height and with a clearance from it. Each protective sleeve 11 comprises an enclosure element or protective sleeve element 11.1 which is for example provided to be rotationally fixed on the rotor 3, i.e. it does not rotate with the respective container plate 9, and which is disposed with the axis of curvature of its pitch-cylinder-shaped interior and exterior surface on the same axis as the container plate axis Y of the associated container plate, and in relation to the machine axis Z is offset radially inwards relative to the associated container plate axis Y. At its upper edge each protective sleeve element 11.1 is connected to a circular disc-shaped enclosure element or protective sleeve element 11.2 which is part of or connected to the plunger 10 and arranged on the same axis as the container plate axis Y.

Each protective sleeve 11 also comprises an enclosure element or protective sleeve element 11.3, which in relation to the machine axis Z is offset radially outwards relative to container plate axis Y and which can be controlled to move down and up to close and open the protective sleeve 11 concerned in an axial direction parallel to the machine axis Z, this being indicated in FIG. 2 by the arrows E and F.

A print head 12 for creating a polychrome print image on a region of the exterior surface of the respective bottle 2 that is provided for the application of this print image, and following this print head 12 a device 13 for fixing the printing ink, are provided sequentially at each printing position 4 in the inner protective sleeve element 11.1 in the direction of rotation D of the container plate 9. The print head 12 consists of multiple individual print heads which can each be digitally or electronically triggered and which operate for example according to the Tonejet principle or Tonejet method, i.e. each individual print head having a plurality of nozzle orifices to dispense the particular printing ink and which are disposed in at least one row parallel or essentially parallel with the container plate axis Y and can be independently triggered to discharge the printing ink. The print head 12 is disposed such that the print direction of the print head 12, i.e. the direction in which the printing ink is dispensed from the print head 12 or from the individual print heads is oriented radially or essentially radially to the machine axis Z so that the discharge of the printing ink onto the respective bottle 2 is assisted by the centrifugal forces generated by the rotating rotor 3.

The individual print heads contain printing inks of different hues, for example red, blue, yellow and black, for generating the different colour separations. The print image concerned and its separate colour sets is/are generated by triggering the print head 12 or the individual print heads respectively according to artwork stored electronically in a computer, this being effected through the controlled rotation of the bottle 2 by the respective container plate 3 about the container plate axis Y and thus about the bottle axis.

Specifically, the printing of the bottles 2 is carried out in such a way that each bottle 2 is transferred to the printing position 4 concerned with the protective sleeve 11 open, i.e. with protective sleeve element 11.3 raised accordingly. At the same time as this transfer, i.e. at the moment when the respective bottle 2 is still held in the infeed star 5, the plunger 10 lowers to secure the bottle 2 against tipping over and the bottle 2 is centred such that the bottle axis lies on the same axis as the container plate axis Y of the corresponding container plate 9. On a first angular range of the rotary motion of the rotor 3 that is contiguous upon the container infeed, the respective protective sleeve 11 is then closed by the controlled lowering of the protective sleeve element 11.3. On a further angular range of the rotary motion of the rotor 3, the printing of the respective bottle 2 is effected with the protective sleeve 11 closed, this being achieved for example in that with each complete revolution of the bottle 2 about its bottle axis, one colour set of the print image is applied with the printing head 12 or with the individual print head assigned to that colour set and that colour set then being fixed with the device 13, this being achieved for example by drying or by a corresponding energy input in the form of thermal energy, e.g. hot air or infrared radiation, UV radiation, microwave energy etc. Subsequently during a further revolution of the bottle 2 about its bottle axis, the next colour set is applied with the print head 12 and this colour set is then fixed with the device 13, and so forth.

Other methods of applying the individual colour sets of the polychrome print image are also possible in principle, by for example the polychrome print image being generated in a single printing process with one print head 12 or with multiple print heads oriented on the container periphery, so-called ‘wet in wet printing’, and then being fixed at the device 13.

Irrespective of the type of printing method, a part of the printing ink does not end up on the particular region of the bottle 2 that is to be printed but together with the air surrounding the bottle 2 forms an aerosol that contains atomized printing ink and would lead to heavy contamination of the printing apparatus 1 with printing ink. In order to avoid this, the printing of each bottle 2 is effected with the protective sleeve 11 closed. To extract atomized printing ink, an extraction system is provided which in the depicted embodiment comprises a plurality of extractor tubes 14 opening out into the interior of the protective sleeve 11 at the upper protective sleeve element 11.2 concerned. These extractor tubes are each connected via collector tubes or pipes 15 to an extraction unit which is common for all print positions 4. To facilitate the extraction of the atomized printing ink, each protective sleeve 11 is configured in such a way that at the lower edge of the closed protective sleeve a slit-like opening remains for a flow of air (supply air) into the interior of the protective sleeve.

Extracting the printing ink that is atomized into the interior of the protective sleeve 11 also in particular prevents printing ink particles settling uncontrollably on the exterior surface of the bottle 2 concerned, thereby potentially impairing the optical appearance of the bottle 2.

In order to reduce the amount of atomized printing ink and to enhance the quality and/or sharpness of the print image, there is provided on the inside of each protective sleeve element 11.1 at least one rod-shaped—for example—electrode 16 upstream of the print head 12 in the direction of rotation D of the container plate 9, to which electrode 16 a high d.c. voltage, for example a d.c. voltage of up to 30 kV, is applied at least before and during the printing process concerned. This high tension effects a static charge of the particular bottle 2 at its region to be printed, such that in the event of an opposite poling of the print head 12 or of the individual print heads, for example to frame potential, the printing ink particles are accelerated in the electrostatic field between the print head and the bottle specifically onto the print region of the bottle. Moreover the tension at the at least one electrode 16 generates a cloud of ions through which the printing ink particles which are floating around are charged up and taken away.

However, enclosing the bottles 2 in the protective sleeves 11 during printing not only prevents the printing apparatus 1 being contaminated by atomized printing ink, the air turbulence around the bottles 2 which impairs the quality of the print image concerned is also avoided through the enclosure. It has to be taken into consideration here that the rotor 3 is rotating at high speed about the machine axis Z especially when the printing apparatus 1 is operated at high output (a large number of printed bottles 2 per unit of time). At each printing position 4 this sets up a considerable flow of air, as indicated by the arrows 17 in FIG. 4. The closed protective sleeve 11 protects the bottles 2 and/or the printed regions against this flow of air 17 during printing. This in turn prevents the discharged ink droplet from being deflected from its flight path, thereby achieving the desired droplet placement and the quality of the required print image. The ratio of droplet velocity to printing speed as specified by the print head manufacturer is therefore not adversely affected by externally acting air flows 17.

It was assumed hereinbefore that upon the transfer of a particular bottle 2 from the infeed star 5 to a printing position or upon the removal of the printed bottle 2 from a printing position 4 at the outlet star 7 (with protective sleeve 11 being open in each case) the particular plunger 10 is lowered and raised respectively. With non-movable plungers 10, it is also in principle possible for the bottles 2 to be raised and pressed up against the plunger 10 at the infeed star 5, and lowered down from the plunger 10 at the outlet star 7, in either case with the container plate 9 and with the opened protective sleeve 11.

It was further assumed hereinbefore that the protective sleeve element 11.3 is lowered and raised under control to respectively open and close the protective sleeve 11 concerned. Other embodiments are also conceivable. It is possible for example to lower the respective protective sleeve element 11.3 to open the protective sleeve 11 and to raise it to close the protective sleeve 11, and/or to provide it pivotably for opening and closing the protective sleeve 11. It is moreover also possible to lower and raise the respective protective sleeve 11 altogether to enclose the respective bottle 2 for printing and to release the bottle 2 after printing.

In a depiction that is similar to FIG. 2, FIG. 5 shows a printing apparatus 1a which in essence only differs from printing apparatus 1 in that a closed protective sleeve 11a configured as a hollow cylinder with a hollow-cylinder-shaped interior and exterior surface is provided for each enclosure during printing. At the container intake or infeed star 5, each bottle 2 transferred to a container plate 9 is now introduced into the protective sleeve 11a concerned from below through the controlled raising of the container plate 9. At the container discharge or outlet star 7, each printed bottle 2 is lowered down out of the protective sleeve 11a through the controlled lowering of the associated container plate 9 so that it can be accepted by the outlet star 7 and transferred on to the outer conveyor 8.

The protective sleeve 11 and in particular its protective sleeve elements 11.1 and 11.3 as well as the protective sleeve 11a are made for example from plastic or from cardboard or paperboard and indeed as disposable elements which can be replaced by fresh protective sleeve elements 11 or 11a respectively when heavily contaminated by atomized or splashed printing ink.

It was assumed hereinbefore that a gap is formed at the lower edge of the respective protective sleeve 11 or 11a through which supply air can flow into the protective sleeve interior when the atomized or splashed printing ink is extracted. Other openings for the supply air may also be constituted in addition to or instead of this, in particular openings in the side wall or in the jacket of the respective protective sleeve 11 or 11a. In this regard it is in particular possible to execute the protective sleeves 11 or 11a with double walls at least in partial regions, and with a multiply perforated wall on the inside such that the supply air that is required for extraction mo longer flows into the protective sleeve interior through a gap at the lower edge of the particular sleeve 11 or 11a but through the space between the outer and the inner wall element and the openings provided in the inner wall element.

The invention has been described hereinbefore by reference to embodiments. It goes without saying that numerous variations as well as modifications are possible without departing from the inventive concept underlying the invention.

### REFERENCE LIST

1, 1a Printing apparatus for printing containers
2 Bottle
3 Rotor
4 Printing position
5 Intake star
6 Outer conveyor
7 Outlet star
8 Outer conveyor
9 Bottle plate or container plate
10 Plunger
11, 11a Protective sleeve
11.1, 11.2, 11.3 Sleeve elements
12 Print head
13 Device for fixing the printing ink
14 Extraction tube
15 Collector tube
16 Rod-shaped electrode
17 Air flow
A Direction of rotation of the rotor 3
B, C Transport direction of the outer conveyor 6 or 8
D Direction of rotation of the container plate 9
E Lowering well of the protective sleeve element 11.3
F Opening well of the protective sleeve element 11.3
G, H Stroke traveled by the particular container plate 9
Y Container plate axis
Z Machine axis

1. An apparatus for printing on containers, said apparatus comprising:
a circumferentially drivable transport element for conveying a plurality of printing positions and/or containers on a closed path of movement between at least one container take-up and at least one container drop,
said transport element having a plurality of print heads for applying at least one print image onto a region to be printed on an external container surface of a containers during relative movement of the external container surface,
at least one print head having at least one enclosure for housing at least the region to be printed of each container that is provided at a printing position.

2. The apparatus of claim 1, further comprising means for extracting atomized and/or splashed operating materials out of the enclosure.

3. The apparatus of claim 1, wherein the at least one print heads comprises an inkjet printhead.

4. The apparatus of claim 1, further comprising a container carrier provided at each printing position, at least one of the container carrier and the at least one print head is controllable to rotate or swivel about an axis to generate relative motion during printing.

5. The apparatus of claim 1, wherein each printing position is assigned its own enclosure.

6. The apparatus of claim 1, wherein at least a part of each enclosure is movably configured to receive and release a container.

7. The apparatus of claim 1, wherein the enclosure comprises a material selected from the group consisting of cardboard, paperboard, and plastic.

8. The apparatus of claim 1, wherein the at least one enclosure has a double wall in at least a partial region thereof.

9. The apparatus of claim 1, wherein said print heads are configured to apply a polychrome image.

10. The apparatus of claim 1, further comprising means for extracting printing ink from said enclosure.

11. The apparatus of claim 4, wherein said container carrier comprises a container plate, and said axis is a container plate axis.
